(19) United States
(12) Patent Application Publication
(10) Pub. No.: US 2009/0127277 A1
(43) Pub. Date: May 21, 2009

(54) Cup Dispenser for Dispensing a Wide Range of Cups in a Vending Machine

(76) Inventor: Morris Douer, Monsey, NY (US)

Correspondence Address: LEVISOHN BERGER, LLP, 32nd Floor, 61 Broadway, New York, NY, 10006, US

(21) Appl. No.: 12/274,102

(22) Filed: Nov. 19, 2008

Related U.S. Application Data
(60) Provisional application No. 60/988,861, filed on Nov. 19, 2007.

(51) Int. Cl. G07F 11/16

(52) U.S. Cl. 221/211; 221/208; 221/210

(57) ABSTRACT

A cup dispenser that dispenses a wide range of cup sizes and cup types. The dispenser comprises a suctioning device that adheres cups by creating a sufficient pressure differential to overcome the weight of a cup to be dispensed. The suctioning device is attached to a mechanism for raising and lowering the same and is thereby lowered to receive a cup and subsequently raised to dispense it. Other embodiments for dispensing cups include a belt that tightens around a cup and a pair of biasing pins that exert pressure against the walls of a cup.

### RELATED APPLICATIONS

This application claims the benefit of provisional application Ser. No. 60/988,861, filed Nov. 19, 2007, the contents of which are incorporated by reference herein.

### FIELD OF THE INVENTION

The current invention relates generally to vending machines, and more specifically to an improved method and apparatus for dispensing cups or food containers of a virtually unlimited range of shape, size and/or diameter

### BACKGROUND OF THE INVENTION

Vending machines are widely used for selling a variety of merchandise such as beverages, snacks, cigarettes and small convenience items. These machines, which are well known in art, are most commonly used to dispense packaged items such as bottled beverages or sealed packages of snacks

Another class of vending machines dispenses unpackaged items such as fresh popcorn, roasted nuts, coffee and the like. With these vending machines, in addition to dispensing a snack or beverage, a cup must also be dispensed for receiving such snack or beverage. To that end, these vending machines typically employ any of various cup dispensers—either automated or otherwise, but all of which function by dispensing the lower-most cup from a vertical stack of nested cups. The stack is positioned in an upright orientation in the dispenser (i.e. cup bottoms facing down), such that the lower-most cup is dispensed in an upright position and is functionally ready to receive product

There are numerous drawbacks and deficiencies associated with these prior art automated cup dispensers. Many have been found to be unreliable in successfully dispensing an individual cup, while others are unsanitary. In addition, the respective ranges of cup sizes and cup diameters of which they are each capable of dispensing are mechanically limited.

As an example, U.S. Pat. No. 5,518,149 to Lotspeich et al. discloses an adjustable cup dispenser for dispensing the lowermost cup of a stack of nested cups by diametrically aligning a plurality of cams in the under-lip area of the lowermost cup. In one orientation the cams support the lowermost cup, but they can be rotated into a second position to mechanically release it. The cams in the Lotspeich patent can be adjusted to accommodate a variety of cup diameters, and is therefore widely used in the vending industry. However, there are inherent mechanical limitations as to how far the cams may be extended inwards and outwards so as to accommodate a wide spectrum of cups and/or containers

In addition, the Lotspeich cup dispenser, although adjustable, can only dispense cups of a single diameter. If another size cup were sought to be dispensed within the same vending machine, a separate second dispenser would be required.

In the current state of the art, the largest cup size that is dispensed from vending machines is one having a 20-ounce capacity and a lip diameter of 3.46″ This presents a restriction in the area of vending fresh foods and beverages. Whereas the size of vending cups are maximized at 20 ounces, the restaurant industry is selling product in cups of up to 46 ounce capacity. Consequently, some in the vending industry have resorted to making cups available for manual retrieval at vending machines when larger cups, which are not capable of being automatically dispensed, are desired. For example, in U.S. Pat. No. 6,187,353 large popcorn cups are placed beside a popcorn vending machine and are accessible by the public This, of course, raises concerns as to the sanitary quality of the cups, and also subjects them to unscrupulous conduct by the public

A further deficiency with the prior art methods and devices for dispensing the lowermost cup is that as cups are dispensed the weight of the stack begins to decrease. When there are only a few cups remaining in the stack there is an increased risk of a jam occurring which will prevent a cup from being dispensed, or alternatively that multiple cups will be dispensed.

Furthermore, in the current state of the art, vending machine cup dispensers are designed to dispense only a specific type of cup—known in the art as a “vending cup.” Vending cups are constructed out of sturdy plastic or paper materials and comprise a sturdy lip. Cups that are constructed of thinner, less expensive materials are prone to jam the dispenser. Moreover, in many systems when a cup is set to be dispensed, the lowermost cup hangs by its rim on mechanical release levers, or cams The weight of the nested stack resting atop thereof necessitates a sturdy rim—known as the “vending cup rim.” Obviously, the strength of the cup material required will increase with the size of the cups, as the weight of the stack increases.

In light of the above and other deficiencies with prior art cup dispensers, there has been a long felt need for a cup dispenser that can efficiently and reliably dispense a wide variety of cups or containers.

### OBJECTS OF THE INVENTION

It is one object of the invention to provide a cup dispenser that dispenses the uppermost cup of a stack of nested cups.

It is another object of the invention to provide a cup dispenser that dispenses cups having a wide range of size, shape and rim diameter.

It is another object of the invention to provide a single dispensing apparatus that is capable of dispensing cups of various sizes within a vending machine.

It is yet another object of the invention to provide a cup dispenser that is capable of vending cups of a wide range of materials.

It is another object of the invention to provide a cup dispenser that reliably dispenses an individual cup or container even when there are only a few cups and containers remaining in a stack.

It is still another object if the invention to provide a cup dispenser that is capable of retrieving cups from various locations within a cabinet of a vending machine.

### SUMMARY OF THE INVENTION

These and other objects of the invention are attained by a cup dispenser that selectively removes an uppermost cup from a stack of cups. The inventive cup dispenser uses an activated suctioning device that engages with the bottom surface of a cup thereby causing the cup to adhere thereto. With the cup securely adhered, the suctioning device is then mechanically raised upward, thereby facilitating the removal of the top cup of a stack It is then transported into a desired area for dispensing, where the suctioning device is inactivated. This triggers the release of a single cup.

The stack of cups is preferably stored in a top-down orientation, thereby leaving the cup bottoms accessible to the suctioning device. As a consequence, however, cups that are lifted by the suctioning device are held in a bottom-up orientation. In order to rotate the cup into an uptight position, the cup is released top down into a cup rotating mechanism, which subsequently rotates the cup by 180°.

In order for the suctioning device to lift a cup, it needs to adhere to a relatively small area of the surface of a cup bottom—regardless of the cup size. A single suctioning device is therefore capable of indiscriminately adhering to the full spectrum of disposable cups or containers—irrespective of size, shape and constituent material.

The stack of cups stands freely on a platform inside the cabinet of a vending machine and no diametrically positioned cams for supporting and dispensing the cups are required. Moreover, the cups dispensed from the inventive dispenser need not have a lip from which to hang prior to being dispensed—as is required in prior systems. In addition, because the upper-most cup is dispensed—and not the lower-most cup—all of the limitations associated with the weight factor of the stack are eliminated as the upper cup does not bear the weight of the stack. Consequently, any type of cup may be successfully dispensed regardless of its weight of constituent materials.

In the prior art, vacuum pumps were employed to dispense cups in commercial manufacturing operations. Those systems employ fixed, powerful vacuum pumps having specialized vacuum heads extending from them. The vacuum heads are configured to fit inside the hollow of a specific sized cup and must deform a cup in order to separate it from the nested stack. Such an arrangement is not feasible for use in a vending machine for several reasons. Firstly, the vacuum apparatus requires a significant amount of energy—in the area of 110 Volts and 12 amps. This puts the vending machine in the position of requiring a dedicated line rated at 20 amps. If such a vacuum were incorporated into a popcorn vending machine or other such vending machines with heating elements or similar devices the machine would require energy in the area of 30 amps thus requiring expensive electrical installation. In addition, a vacuum or vacuum pump is excessively noisy, making it unsuitable for vending purposes. The vacuum pump also occupies a large amount of space in the cabinet of a vending machine. Importantly, these cup dispensers can dispense cups of only one given size and because the cups must be deformed in order to separate them from the stack, they are not capable of dispensing Styrofoam cups.

In the current invention a low voltage, low amperage pump in combination with a vacuum cup or suction cup is utilized. Enough suction is thereby generated to adhere and separate a cup from its position in a nested stack.

Alternatively, instead of suction, a pair of biasing pins is utilized to exert pressure against the inside walls of the lower lip of a cup.

Embodiments of this invention allow for the successful dispensing of cups and/or containers of different sizes, shapes and weights from within the same vending machine yet with a compact design, high-energy efficiency and virtually silent deployment.

### BRIEF DESCRIPTION OF THE DRAWINGS

FIG. 1 is a perspective view of a cup dispenser apparatus according to an embodiment of the invention.

FIG. 2 is a perspective view of an elevator within an enclosure aligned with one of two cup storage compartments according to an embodiment of the invention.

FIG. 3 is a perspective exploded view of an elevator and enclosure according to an embodiment of the invention.

FIG. 4 is a perspective view of a cup dispenser apparatus according to an embodiment of the invention, whereby a cup is suctionally adhered to a inflator/deflator pump.

FIG. 5 is a perspective view of an adjustable cup-storage compartment according to an embodiment of the invention.

FIG. 6 is a side perspective view of a cup dispenser according to an embodiment of the invention wherein an inflator/deflator pump is connected to a linear movement track.

FIG. 7 is a side perspective view of a cup dispenser according to an embodiment of the invention wherein a peristaltic pump is connected to a linear movement track

FIG. 8 is a front, perspective view of a cup transport system in one embodiment of the invention, which includes a cup-rotating mechanism. A cup is shown in the process of being rotated by the rotating mechanism.

FIG. 9 is a rear perspective view of one embodiment of a cup rotating mechanism according to an embodiment of the invention.

FIG. 10 is a flow diagram showing how the picker is deployed according to an embodiment of the invention.

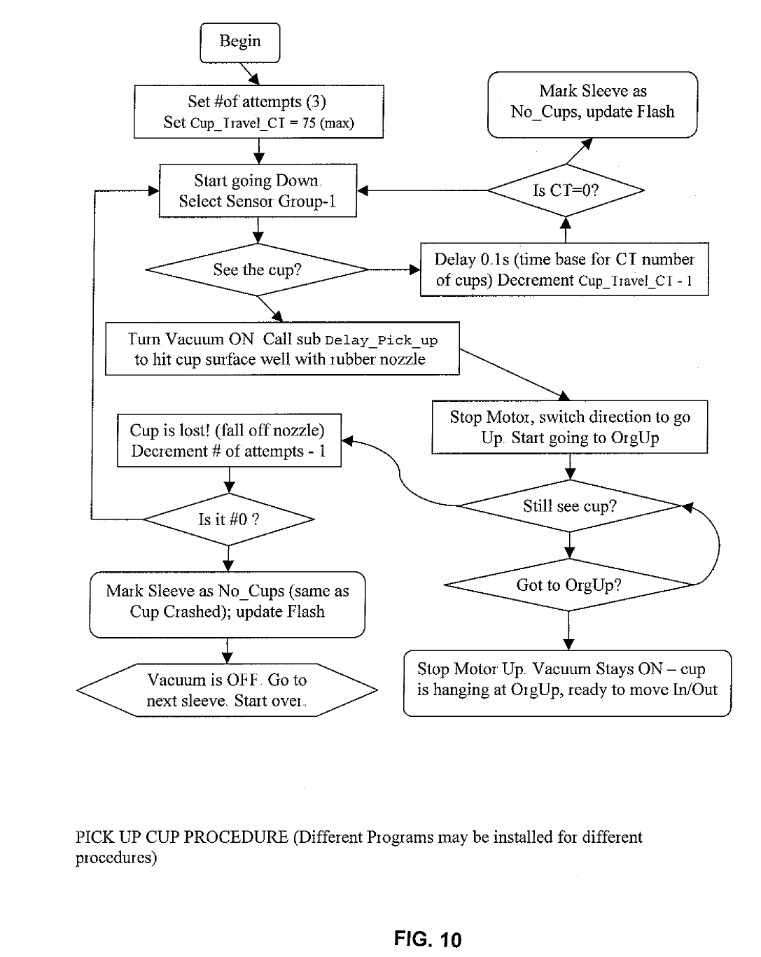

FIG. 11 is a flow diagram showing how the picker is deployed according to an embodiment of the invention.

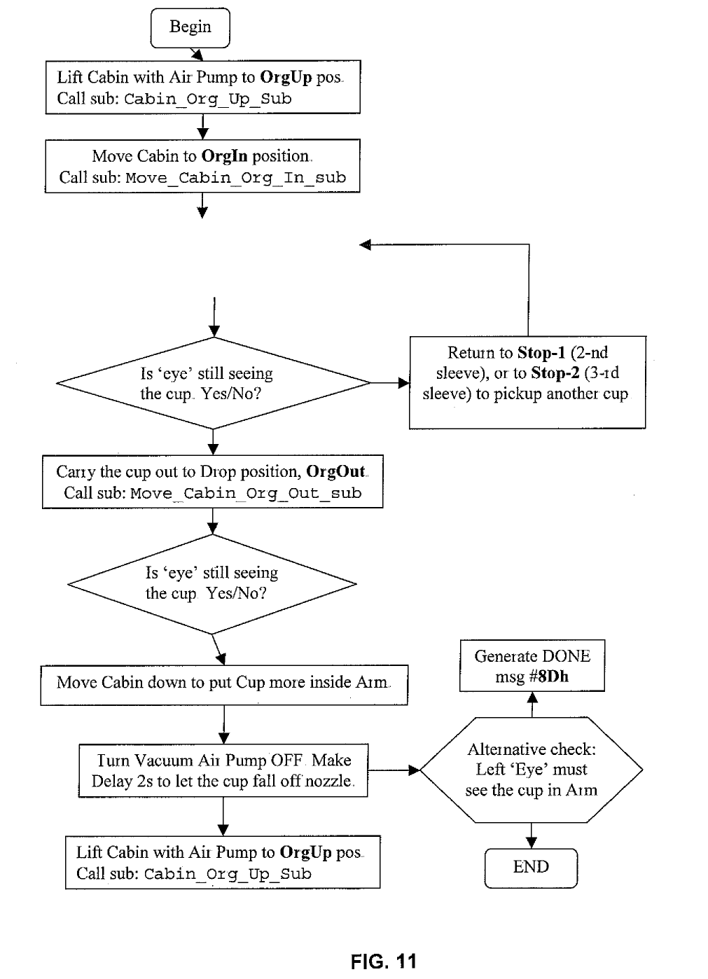

FIG. 12 is a flow diagram showing how the picker is deployed according to an embodiment of the invention.

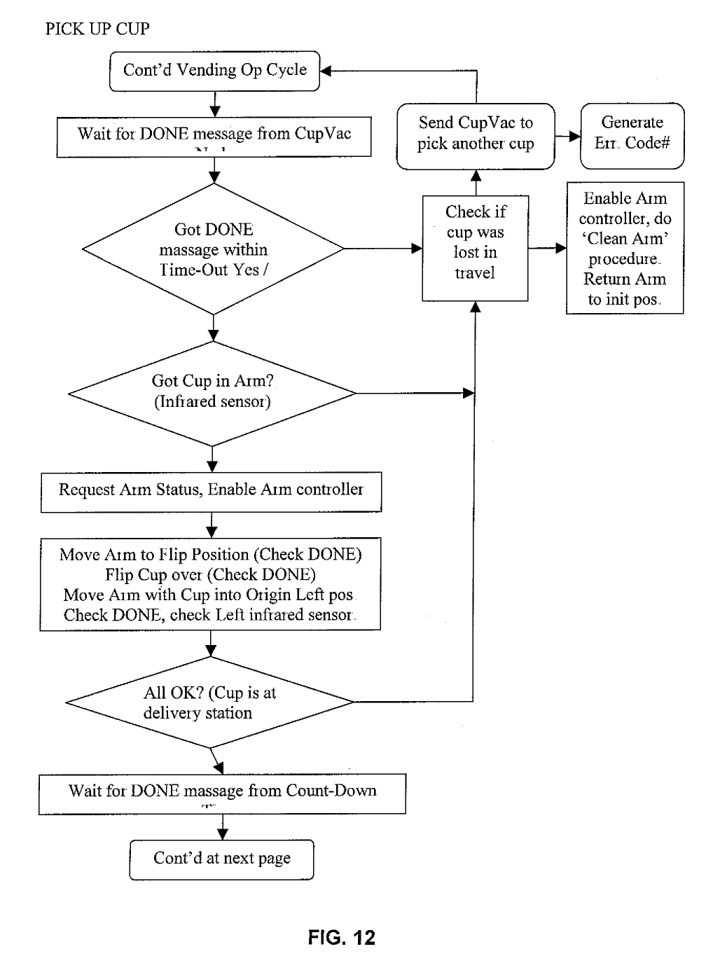

FIG. 13 is side perspective view of a cup dispenser according to an embodiment of the invention whereby a suction cup attached to a linear track is guided into a sleeve of cups.

FIG. 14 is a front perspective view of a cup dispenser whereby the bottom cup of a nested cup is suctioned.

FIG. 15 is an exploded view of the cup dispenser of FIG. 14

FIG. 16 is a front perspective view of a cup dispenser whereby the bottom cup of a nested cup is suctioned.

FIG. 17 is perspective view of a cup picker comprising biasing pins for lifting cups.

FIG. 18 is a top view of a cup picker comprising a belt for encircling and grasping a cup.

### DETAILED DESCRIPTION OF THE INVENTION

Embodiments of the present invention will now be described with reference to the above-identified figures. However, the drawings and the description herein of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

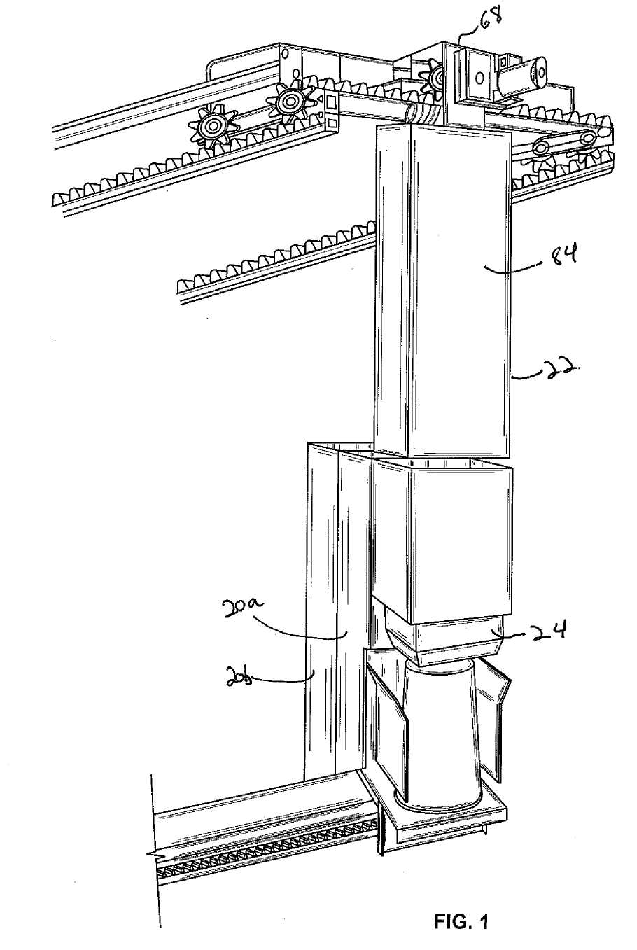

Referring to FIG. 1, an embodiment of the dispenser is shown having a plurality of cup storage compartments 20a, 20b. An elevator guide 22 is shown with a suspended elevator 24 partially extending therefrom. The elevator 24 encloses a suctioning device, which provides suction for lifting cups.

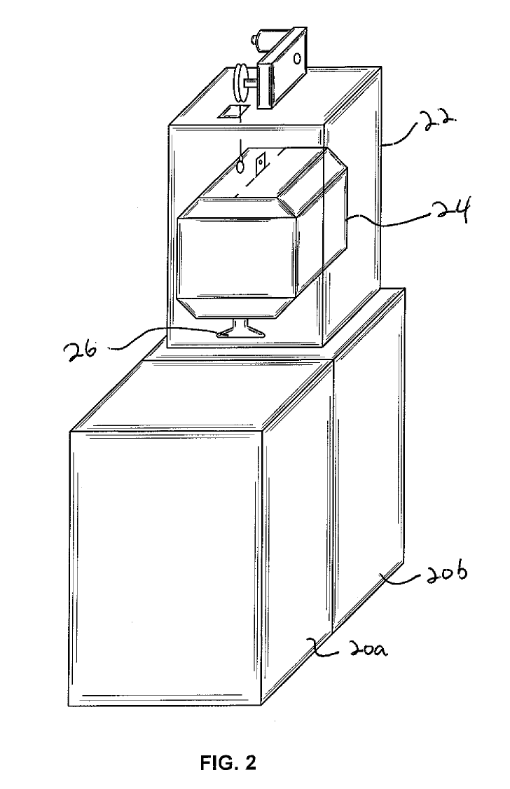

In FIG. 2 an enlarged view of the elevator 24 within the elevator guide 22 is shown The elevator guide 22 is aligned with a cup storage compartment 20b. The suctioning device is secured within the elevator 24 and is provided with a suction hose descending therefrom. The distal end of the hose comprises a downward facing suction nozzle or vacuum suction cup for suctionally adhering cups and/or containers. The pump is preferably entirely encased within the cavity of elevator 24 and only the suction tip 26 protrudes therefrom. A cup is suctionally adhered when a pressure differential is generated by the suctioning device such that it causes a cup to be drawn to, and adhere to (as a result of sucking action) a nozzle, suction cup, vacuum cup or similar opening that is in communication with the suctioning device

It will be understood by those of ordinary skill in the art that any pump that creates suction such as, but not limited to, peristaltic pumps, impeller pumps and transfer pumps may be utilized for adhering cups. Furthermore, the distal end of a hose descending for a suctioning device could be provided with any of a variety of possible attachments for assisting in tightly adhering cups. These include suction cups and vacuum cups and are referred to generally herein as “suction tips.” Alternatively, the terminal end of suction hose could be utilized for suctioning cups without the assistance of any other devices. Still further, it will be understood that a suctioning device may be configured to directly contact a cup surface without the need for an intermediary such as a suction hose and/or suction cups. Alternatively, a suction cup or vacuum cup could be in direct contact with a suctioning device for contacting and adhering cups.

Suctioning devices such as inflator/deflator or peristaltic pumps typically have an uneven distribution of weight. Thus, when suspended from a cord, the pump would tend to list toward its heavier side and a result the suction tip descending therefrom would possibly miss its target in the center of the cup. In one embodiment of the invention this is resolved by affixing the pump to a guide such as the elevator 24 shown in FIGS. 1-3. The elevator 24 serves to counter-balance the weight of a suctioning device and to guide the suction tip 26 into and out of cup storage compartments 20 and the elevator guide 22.

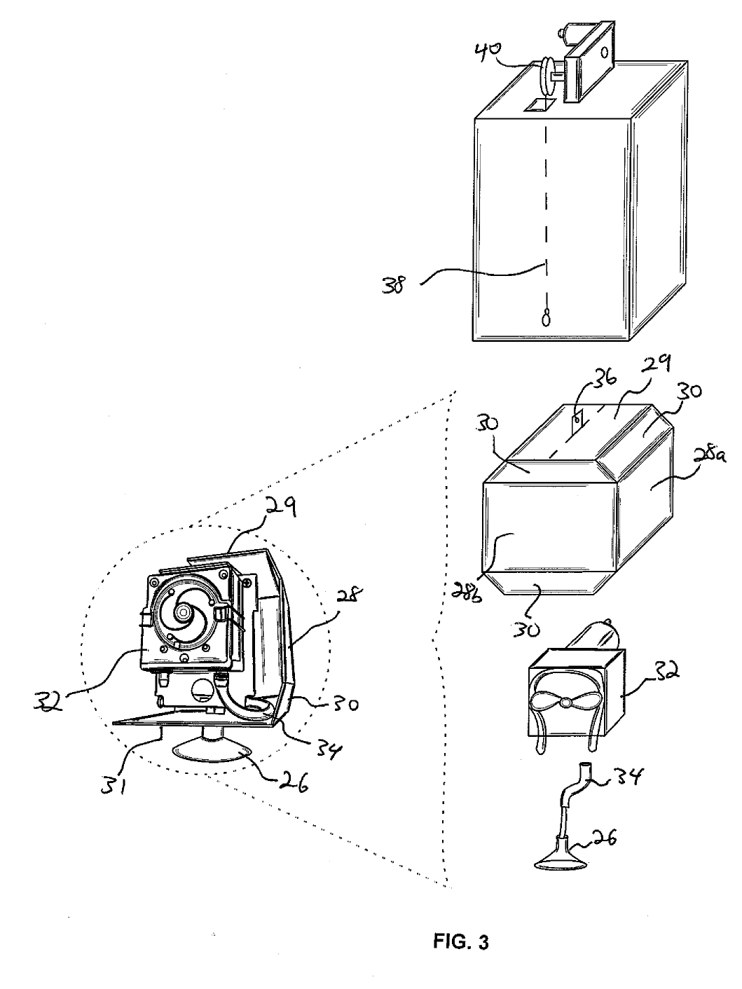

As shown in FIG. 3 elevator 24 comprises vertical side walls 28a, 28b and a top 29 and bottom wall 31. The upper and lower portions of the side walls 28 angle inwardly to form a box that is tapered on its top and bottom. The angled juncture 30 ensures that the elevator 24 transitions smoothly from the elevator guide 22 into and out of cup storage compartments 20. In the event that the elevator lists laterally when it travels between the guide and compartment 20—rather than getting caught on the wall of the compartment—the angled juncture 30 guides the elevator smoothly into the cavity of the guide or compartment.

FIG. 3 shows an elevator 24, which is essentially hollow Peristaltic pump 32 is encased within and attached to the elevator 24. A vacuum hose 34 is shown, which has a first end that is inserted into the pump 32 and a second, distal end, which comprises a suction cup 26 (or vacuum cup). The top 29 of the elevator 24 comprises a means, such as a tab 36 or an aperture for attaching to a cord 38 or the like. Cord 38 hangs from a pulley wheel 40, which raises and lowers the elevator 24 by rotating bi-directionally.

Also shown in FIG. 3 is a cross-sectional view of an elevator 24 with a peristaltic pump 32 secured therein. As shown, pump 32 is attached to the inside of the elevator 24. A hose 34 extending from the pump exits the elevator through an opening in the bottom wall 31 of the elevator 24. The distal end of the hose is provided with a suction cup 26, which contacts cups.

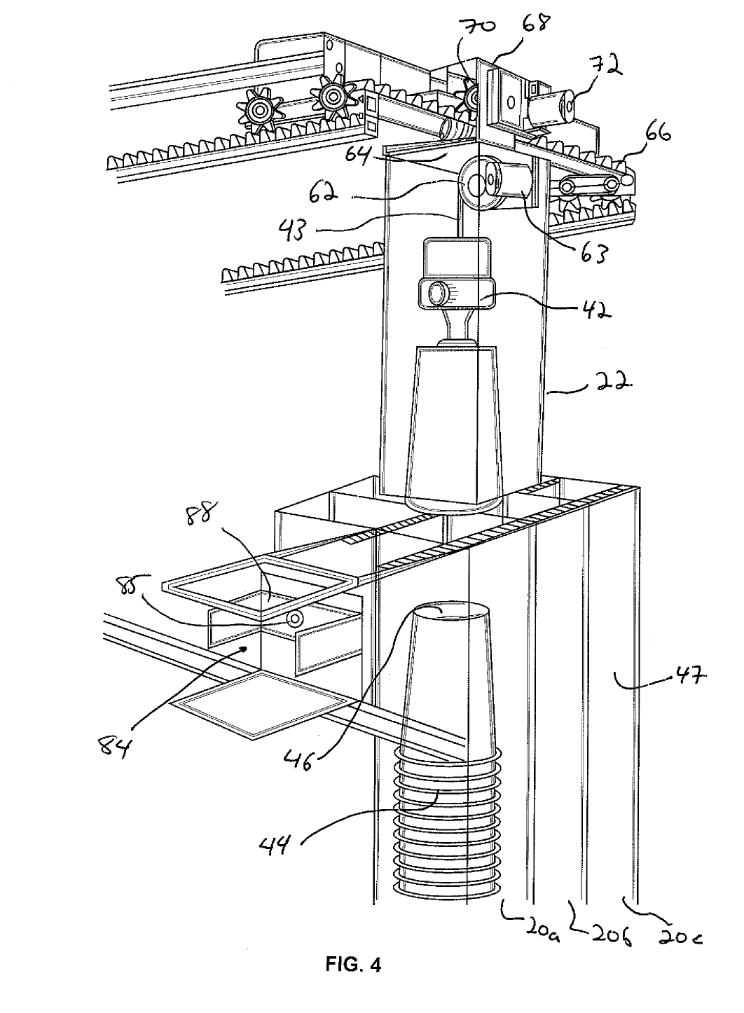

In one preferred embodiment, as shown in FIG. 4 a standard inflator/deflator pump 42 having a 12V motor is utilized for generating suction. The deflating end of the pump generates an area of low pressure extending from the suction hose that creates a suctioning force powerful enough to separate and lift a cup as large as a 64 oz. Popcorn cup from its nested position in a stack. It should be noted that although there may be some adhesive force between an uppermost cup and the cup therebelow (e.g. due to frictional forces, and/or the tight fit of a cup within another), the suctioning force of the pump 42 described herein overcomes any such cup-to-cup adhesion

Optionally, however, to help ensure that the upper most cup successfully separates from the one therebelow, an air blower may be directed to the general area at which lips of two nested cups align. Blowing action of such air blower assists in the separation of the cups. In one embodiment, the air blower comprises the inflator end of an inflator/deflator pump 42.

It will be under stood by those of ordinary skill in the art that pump 42 may be secured within an elevator or it could be tethered directly to a cord 43 or any other z motion mechanism.

As further shown in FIG. 4 in a preferred embodiment of the invention, stacks of cups 44 are positioned in the vending machine in a top-down orientation, leaving the bottom surfaces 46 of the cups accessible to the suctioning device 42 The stacks are preferably stored in columnar storage compartments 20 inside the cabinet of a vending machine. As shown, a vending machine may have a plurality of separate storage compartments 20a, 20b, 20c, each of which comprises an enclosure sized to accommodate a stack of cups or containers of a particular diameter and is formed by a series of walls 47, which extend vertically to surround the stack of cups 44 or containers. Columnar storage compartments 20 may comprise partial walls, or complete walls. Storage compartments may further be constructed in various sizes and/or shapes to correspondingly accommodate various sized and/or shaped cups and containers.

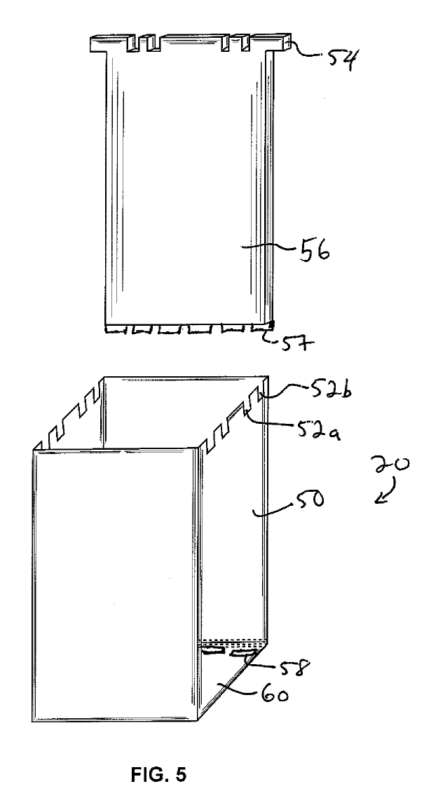

Referring to FIG. 5, in an embodiment of the invention, storage compartments comprise adjustable walls. In this embodiment, the side walls 50 of storage compartment 20 are provided with a plurality of grooves 52a and 52b for selectively accommodating an upper protrusion 54 on a removable wall panel 56. Removable panel 56 also comprises a plurality of lower protrusions 57 on its bottom surface for selectively engaging a corresponding plurality of grooves 58 in the floor 60 of cup storage compartment 20. The grooves 52 on the side walls 50 are aligned with those of the floor 58 Thus, the length of a storage compartment is adjusted by inserting removable panel into a desired groove. Fox example, in a fresh popcorn vending machine, removable wall panel 56 is inserted into groove 52a for dispensing cups and is inserted into groove 52b for dispensing larger cups or tubs. A similar system can be employed for adjusting the width of a compartment.

It will be understood by those of ordinary skill in the art that in the current invention any of various numbers or configurations of cup-storage compartments is possible. For example, there can be several rows of compartments. To reach all compartments, a saddle member is provided with the linear tracks for forward and backward as well as side-to-side movement. Cup storage compartments could alternatively be positioned in any of various configurations—such as for example in the shape of a horseshoe, or around the outer perimeter of a cup dispenser.

Referring to FIG. 4, suctioning device 42 is suspended from a cord 43 having a first end tethered thereto and a second end tethered to a grooved pulley wheel 62. Pulley wheel 62 is secured to an upper support member 64, which will be described in more detail below. Cord 43 thereby connects suctioning device 42, or an elevator that encases a suctioning device, to an upper support member 64. The pulley wheel 62 is coupled to a motor 63 having bi-directional controls for rotating the pulley wheel 62 in a clockwise or counter clockwise orientation about its axis. Rotating the wheel 62 in either direction causes the cord 43 to respectively wrap around the circumference of the pulley wheel 62, or unwrap therefrom, causing the suspended suctioning device to be respectively raised or lowered with respect to the ground.

In a preferred embodiment, pulley wheel 62 and suctioning device 42 tethered thereto are connected to an upper, linear motion track 66 by means of a saddle member 68, which moves linearly along track 66. In one embodiment, track 66 comprises a rack and pinion apparatus In this embodiment, saddle member 68 is provided with a pinion or spur gear 70 coupled to a gear motor 72. Teeth on spur gear 70 mesh with teeth on a fixed horizontal rack 66, such that the rotation of spur gear 70 about its axis causes the two-dimensional, linear movement of the saddle member 68 to which it is affixed. It will be understood by those of ordinary skill in the art, that linear motion may be achieved by any of a variety of linear movement devices such as, but not limited to, linear guide tracks, pulley mechanisms, conveyor belts and timing belts—all of which are well known in the art.

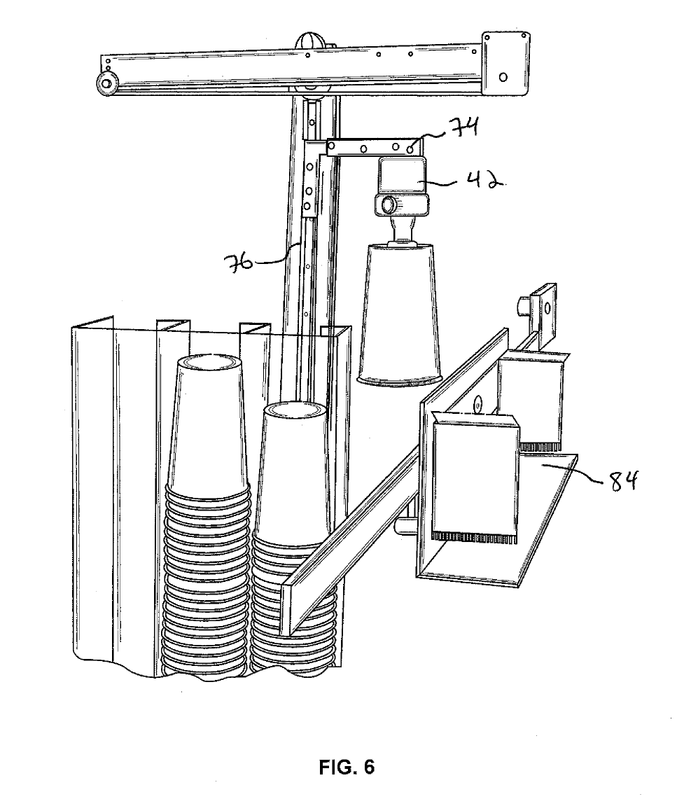

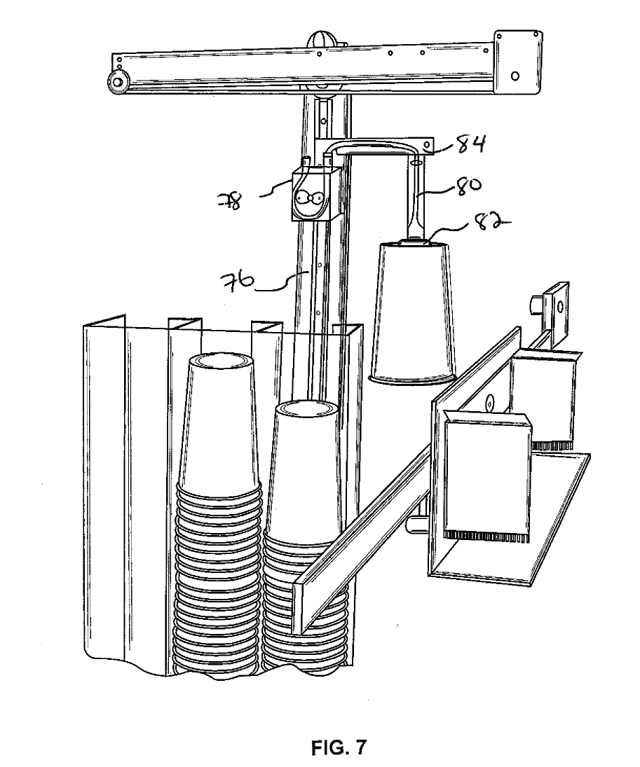

In a preferred embodiment, saddle member 68 moves horizontally to align the suctioning device 42 roughly above the center of a stack of cups 44 Once aligned, the pulley wheel 62 is rotated to lower the activated suctioning device 42 in order to adhere the upper-most cup in the stack. It will be understood by those of ordinary skill in the art, that the vertical motion of suctioning device 42 may be achieved by attaching it to any of a variety of linear movement devices such as, but not limited to, linear guide tracks (as shown in FIGS. 6 and 7), pulley mechanisms, conveyor belts and timing belts—all of which are well known in the art

In some embodiments, the pump is held securely in the proper orientation by affixing it to a bracket or a similar supporting member. For example, FIG. 6 shows an inflator/deflator pump 42 affixed to a bracket 74. A first end of bracket 74 is secured to a linear track 76 for z motion and the second end of the bracket is affixed to the pump 42. In FIG. 7, a peristaltic pump 78 is attached to a linear track 76. A tube 80 having a suction cup 82 at its distal end is in communication with the pump and extends therefrom. The suction cup 82 is affixed, in the proper orientation, to bracket 84.

In a preferred embodiment, and as shown in FIGS. 1, 2 and 4 suctioning device 42 or elevator 24 is surrounded by an enclosure 22 which functions as a guide therefore. Guide 22 comprises walls 84, which extend downwardly from saddle member 68 and connect to each other to form a hollow column. The perimeter dimensions of guide 22 preferably substantially match those of columnar storage compartment 20, such that guide 22 and storage compartment 20 align (as shown in FIG. 1) to form a substantially continuous hollow column which confines suctioning device 42 or elevator 24 for essentially its entire distance that it travels to retrieve and release a cup Thus, guide 22 and storage compartment 20 act as a physical barrier to any significant lateral movement of suctioning device 42 or elevator 24 in order to ensure that suctioning device does not sway in a lateral direction and possibly miss its target i.e. the bottom of a cup. Note that in this application, a suctioning device (either incorporated into an elevator or otherwise) is alternatively referred to as a “picker” herein.

As best shown in FIG. 4, the adhered cup is held upside-down by suctioning device 42 and must be rotated to an upright position to be functionally useful To that end, an embodiment of the invention is directed to an apparatus and method for rotating a cup or container. In this embodiment, the activated suctioning device 42 with a cup or container adhered thereto is moved into an area above a cup-rotating mechanism 84. Once generally aligned with cup-rotator mechanism 84, the suctioning device 42 is deactivated. Upon termination of the sucking action, a cup drops upside-down into cup-rotating mechanism 84.

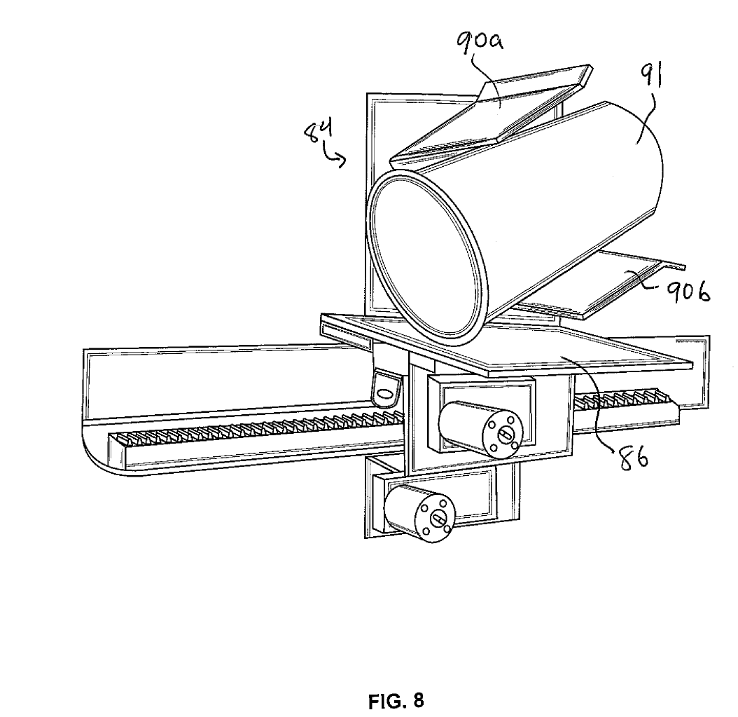

As shown in FIG. 8, cup-rotating mechanism 84 comprises at least a floor or base 86 for supporting a cup or container and a rotatable wall 88 having a pivot 85 (as best seen in FIG. 4) in its general center. Two parallel support arms 90a, 90b protrude from rotatable wall 88 and are roughly spaced to accommodate a cup or container Pivot 85 is coupled to a motor, which upon activation rotates rotatable wall 88 by 180°. When rotatable wall 88 is rotated, attached support member 90a, 90b contact the sides of a cup 91, and thereby rotate the same to an upright position.

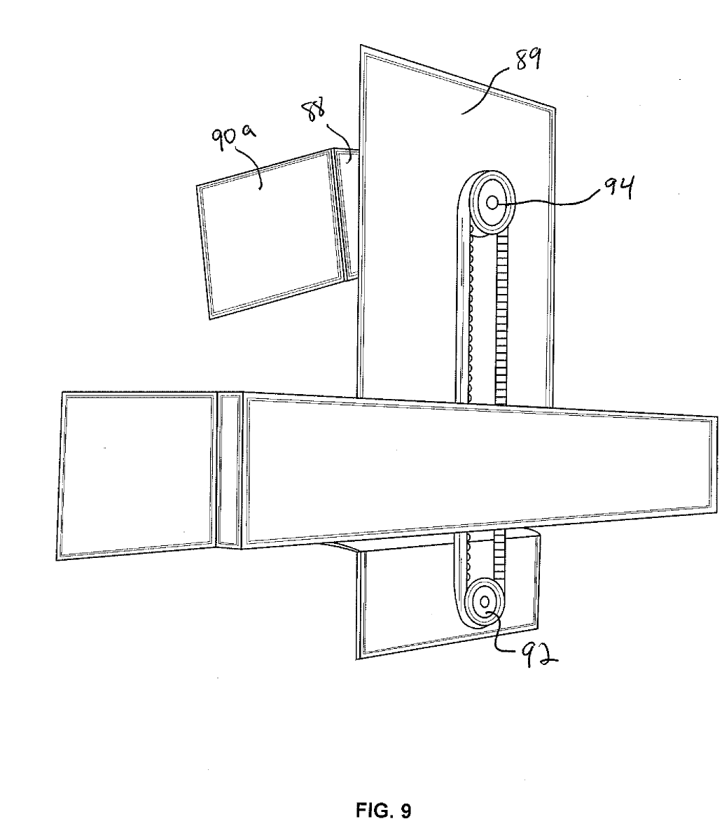

FIG. 9 shows a rear view of the cup rotating mechanism according to an embodiment of the invention. As shown, a first wheel 92 coupled to a bi-directional motor controls a second wheel 94 by way of a belt 96. Second wheel 94 is connected to pivoting member 85. When first wheel 92 is rotated, second wheel 94 and attached cup support members 90a, 90b are rotated.

Rotating wall 88, may be attached to a wall 89 disposed orthogonally thereto or to another part of the vending machine.

It should be noted that cups may optionally be released from suction device 42 without being rotated to an upright position. This would be desirable, for example, in a vending machine wherein a cup is dispensed for retrieval by a consumer who may then place it beneath a dispensing spout to receive product. In such a vending machine, a consumer will orient the cup to an upright position and it need not be done by the cup dispenser.

In another embodiment, a stack of cups is positioned in a vending machine in an uptight orientation. In this embodiment, a suctioning device having a hose and a vacuum suction cup or nozzle descending therefrom is inserted into the space of an upstanding cup to contact the cup's bottom. In this embodiment, a cup dispenser functions as described above, except that an adhered cup is held in an upright orientation an need not be rotated for receiving product.

The cup dispenser is controlled by software that is programmed to control various functions thereof. In a preferred embodiment, an elevator or suctioning device (both of which also referred to herein as the “picker”) is provided with a downward pointing infrared detector. The infrared detector is programmed to detect an object within a premeasured distance. For example, the infrared detector is programmed to detect a cup when it comes within 15 centimeters therewith. Thus, when the picker is deployed into a cup compartment to lift a cup, as soon as the infrared detector detects a cup bottom, the software is programmed to lower the picket a premeasured distance (e. g. 15 centimeters) to reach a cup. In one embodiment, the suctioning device is activated after the picker reaches a cup or alternatively it can be activated at an earlier time, for example, during its travel down a storage compartment.

In one preferred embodiment, the infrared detector has a number of levels of detection. For example, an infrared detector is utilized which has 256 levels of detection The infrared detector can thusly detect how many cups are remaining in each compartment—without needing to travel into the compartment. Such information is then sent to a memory board in the vending machine. Importantly, the information can be sent via a wireless transmission (e.g. via wireless modem or other wireless transmission which is well known in the art) to a central station. In this manner, vending machines in various locations could be monitored and replenished and/or serviced accordingly

In another embodiment, a vending machine takes stock of the number if cups remaining in each compartment by calculating the distance that the elevator or suctioning device had to travel in order to reach a cup. Preferably the infrared detector is programmed to scan each row of cups when the vending machine is idle (when is not in a vend cycle). The vending machine's main board has flash memory and timer which remembers when vend cycles are least likely to occur in order to activate such a scanning routine. The picker, having an infrared sensor mounted thereon will travel inside of each cup compartment and try to pick up a cup and release it. It will relay back data to the memory board, such as a precise calculation of the drop it had to assume in order to pick up a cup. Each stacked cup comprises a measured distance of travel. A long drop means few cups are left. If the picker is unable to pick up a cup, it will register that that the picker should not attempt to dispense cups from that particular compartment during a vending cycle. The software is further programed to determine if the infrared detector did not detect a cup or if the detector did detect a cup, but could not lift it. If the picker does not detect a cup, the particular compartment will be registered as “empty,” whereas if the detector detected a cup, but could not lift it, it will register that there is an error in that particular compartment. An error might be caused by a cup that is deformed or otherwise improperly stacked. If the compartment is registered as empty or as an error, the software is programmed to not send picker into that particular compartment until the memory is reset—i.e. after an operator has replenished the cups.

Importantly, once a cup is suctionally adhered to a picket, the infrared detector constantly registers to the main controller that it still “sees” the attached cup If the detector prematurely stops “seeing” the cup, the system is configured to make a new attempt to lift a cup

Once cups are stacked an operator presses a reset button to reset the memory with a new amount of cups. Alternatively, the memory is automatically reset by a built-in switch. For example, the vending machine is configured with a switch that is activated automatically during restocking. For instance, moving the cup compartments forward releases a micro switch and by pushing it back to its position once it is all filled with cups, the micro switch is hit again sending a signal that new cups are stacked. Alternatively, once the vending machine door is closed prior to the machine going back into ready mode, picker will perform a cup scanning routine described above. This scanning routine will also inform flash memory it cups where indeed stacked properly. If machine has a wireless modem, the job of the operator of that vending machine can actually be reviewed by a supervisor who gets electronic data of the entire procedure and the machine's own review of that procedure and results

In the embodiments of the invention described above, a cup storage compartment must be wide enough to accommodate a suctioning device therewithin. The above embodiments would thus be precluded from use with a slender cup compartment—whose inside dimensions are smaller than the outside dimension of a suctioning device.

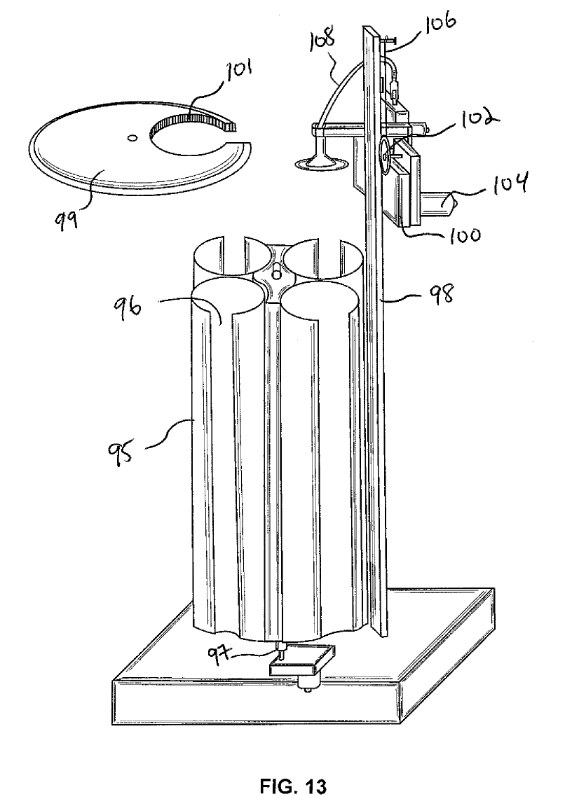

To address this limitation, the cup dispenser of the invention is modified such that only the suctioning head is lowered into the cavity of the cup storage column—with the suctioning device remaining outside thereof. In one embodiment, this is achieved with the cup dispenser shown in FIG. 13, which comprises a slender storage compartment 95 having a slot 96 running the length thereof.

In this embodiment, suctioning device is attached to a z motion mechanism that is situated outside of a cup storage compartment. A suction hose extending from the suctioning device is inserted into the storage compartment via the slot therein. This allows for the suctioning device to be raised or lowered outside of the confines of a cup storage compartment.

FIG. 13 shows a track 98 and a saddle member 100 to which a suctioning device (not shown) is affixed. A pulley wheel 102 that is coupled to a bi-directional motor 104 is attached to the saddle member 100. The pulley wheel 102 is tethered to a cord 106 that is secured at the top of track 98. Saddle member 100 and suctioning device affixed thereto thusly is raised and lowered by the respective rotation of wheel 102. It will be understood by those of ordinary skill in the art that vertical motion of suctioning device may be achieved by attaching it to any of a variety of linear movement devices such as, but not limited to, linear guide tracks (as shown in FIG. 4), pulley mechanisms, conveyor belts and timing belts—all of which are well known in the art.

Vacuum hose 108 is inserted into cup storage compartment via slot 96, which extends the length (or a portion of) cup storage compartment 95. Optionally, several storage compartments 95 are disposed on a rotatable pivot for presenting compartments in turn to the suctioning device. In addition, compartment 95 may be provided with a cover 99 having a cut out lined with brushes 101 for separating cups—should two cups be dispensed.

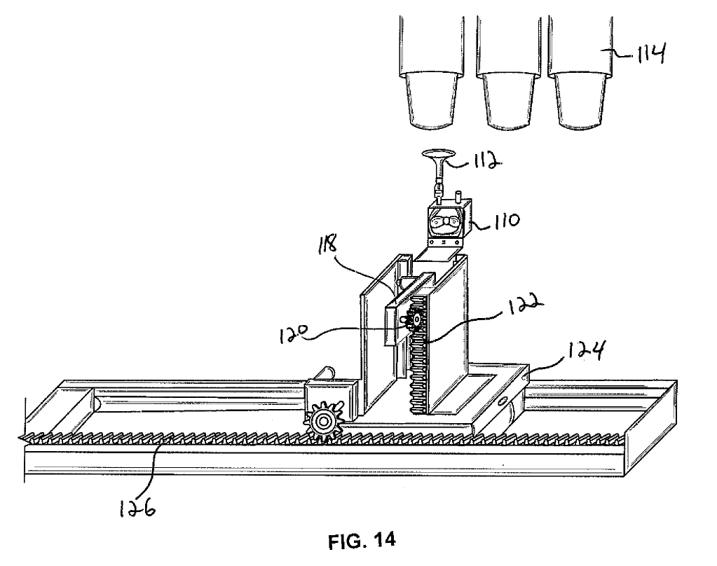

In other embodiments of the invention, the inventive dispenser is configured to dispense the bottom-most cup in a nested stack of cups. For example, referring to FIG. 14, a suctioning device 110 is shown that is coupled to a z motion rack and pinion track In this embodiment, an upward facing suction cup 112 is provided for adhering a bottom cup of a stack of nested cups that are dispensed from a standard pull-type cup dispenser 114. In this embodiment, standard pull-type dispensers may be utilized. Importantly, the dispenser of this embodiment can efficiently dispense Styrofoam cups. This is very beneficial for vending purposes. Styrofoam cups are usually the best option for vending hot beverages, and the vending industry has not developed a reliable method of dispensing them.

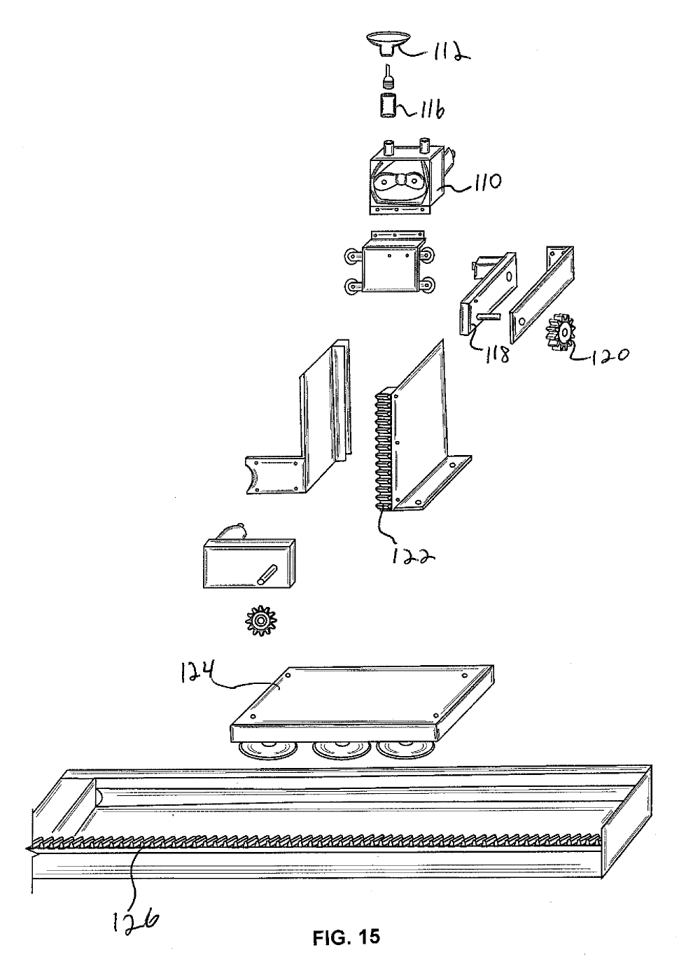

FIG. 15 shows an exploded view of the dispenser of FIG. 14. As shown, a peristaltic pump 110 is provided with an upward extending pipe 116, which terminates in a suction cup 112. The pump 110 is affixed to a support arm 118 having a gear wheel 120 attached thereto. The gear wheel 120 aligns and meshes with teeth on a vertical track 122. A motor 124 coupled to the gear wheel 120 rotates the gear wheel 120 to effectuate upward and downward movement of the pump 110 To dispense a cup, gear wheel 120 is rotated in one direction to raise the support arm 118 and attached suctioning device in order to align suction cup 112 with the bottom of a cup. The activated suctioning device thereby adheres a cup. After the cup is suctionally adhered, wheel 120 is rotated in the opposite direction to lower the cup and thereby remove it from its nested position in a stack.

In one preferred embodiment, and as shown in FIGS. 14-16 the entire mechanism for raising and lowering pump is disposed on a movable platform 124. Platform 124 is located on a linear motion track 126 such as a rack and pinion In operation, a cup that is removed from the bottom of a stack and is suctionally adhered to the suction cup can be moved to another location in a vending machine in an upright orientation in order to receive product.

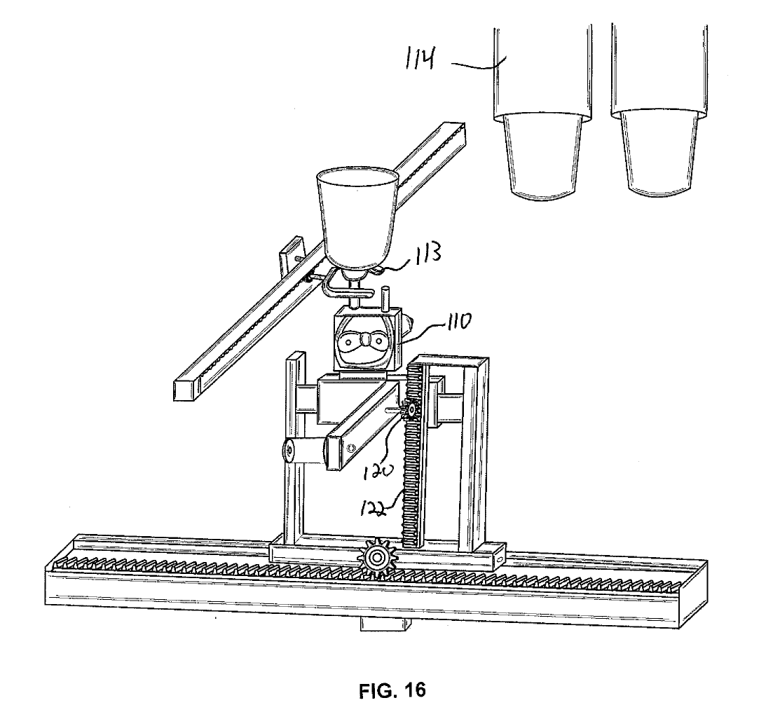

In FIG. 16 a cup 128 that is suctionally adhered to a suction cup 112 is moved laterally along a track. In some embodiments a cup is received by a cup receptacle 113—which itself may be attached to a linear motion track.

In another preferred embodiment a cup is removed from its nested position in a stack by a mechanism that applies outward pressure to the inside walls of a cup and thereby grips the cup in order to remove it from a stack.

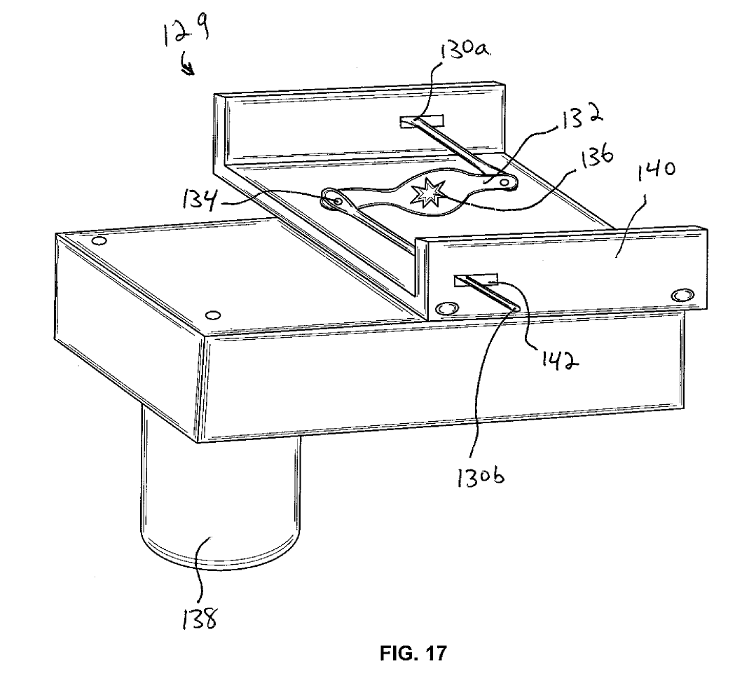

FIG. 17 shows an embodiment of the invention, which utilizes retractable pins 130a, 130b for applying a biasing force against the wall of a cup. As shown, pins 130 are movably connected to central pivoting member 132, such as by way of a rivet 134 or similar member, which acts as a fulcrum for the movement of pins 130. A first pin extending from pivoting member is positioned in the opposite direction of a second pin Pivoting member 132 is attached in its center to a shaft 136, which is coupled to a bi-directional motor 138. The motor 138 is used to pivot the pivoting member 132 bi-directionally. A pin guide is provided for constraining the movement of pins. In a preferred embodiment, pin guide comprises a wall 140 and an aperture 142 through which pin is inserted Aperture 142 thus directs pins outward.

In operation, pivoting member 132 is set in a position such that pins 130 are not extending or are minimally extending In order to dispense a cup, the assembly is lowered (or raised) into the hollow of a cup such that the pins 130 are facing the walls thereof Once inside the cup, the motor 138 is engaged which rotates pivoting member 132 to cause pins to extend outwardly through aperture 142. Pins 130 thusly exert outward pressure on a wall of a cup to effectively grip the cup. Once the cup is gripped, the assembly 129 is raised (or lowered) to separate a cup from its nested position in a stack. To release a gripped cup, the motor is rotated in the reverse direction to thereby withdraw the pins 130 and release its grip on a cup. (Note for purpose of clarity: if the pivoting member were viewed standing upright, and a top pin were extending outwardly to the right and a bottom pin were extending outwardly to the left, a clockwise rotation of the pivoting member would cause the pins to extend outwardly to grip a cup and a counter clockwise rotation of the pivoting member would correspondingly withdraw the pins and release a cup If the top pin extended to the left and the bottom pin to the right—then the reverse would be true).

This embodiment of the invention could be used to grip cups from the hollow of the cup or preferably it is used to grip the bottom of a paper cup. Most paper cups comprise walls that extend downwardly passed the floor of the cup. The area that extends passed the floor is referred to herein as the cup lower lip

The current embodiment can thusly be utilized to dispense a lower-most cup from a stack of cups. In operation, a stack of paper cups is positioned in a standard pull-type cup dispenser with the bottom cup extending therefrom. With these dispensers, the bottom-most cup extends from the dispenser and is removed by gripping the cup and drawing it downwardly. The pins assembly 129 is affixed to a linear motion track in the orientation shown in FIG. 17 and is raised such that the pins are positioned within a hollow area defined by a cup's lower lip Once inside the confines of the lower lip, the pivoting member 132 is rotated as described above to grip and release a cup.

Another embodiment of the invention for dispensing a lower-most cup in a stack is adapted to dispense a virtually unlimited range of cup/container sizes. In this embodiment, a stack of cups is positioned in a cup dispenser such as a pull-type dispenser, as described above.

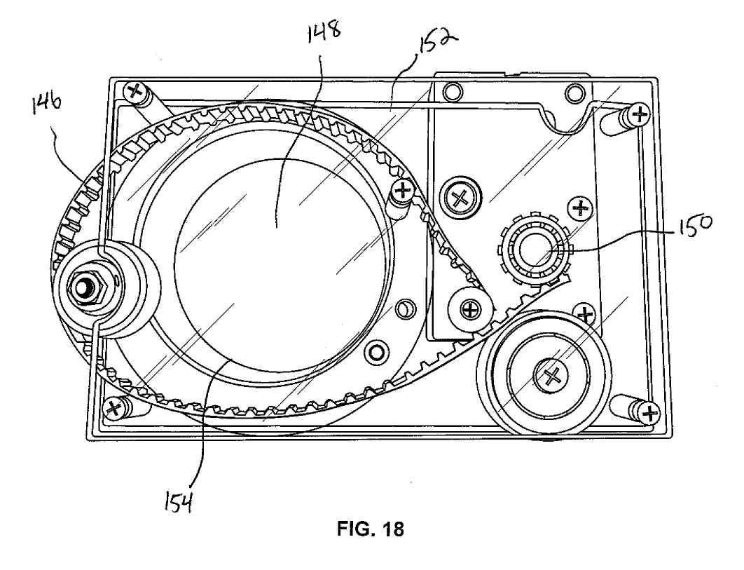

The current embodiment comprises a mechanism for mechanically gripping a cup and drawing it downward in order to separate it from its position in a stack. Referring to FIG. 18, which shows a bottom view of a belt mechanism 144, a belt 146 is shown which is folded or bent to encircle or partially encircle an area which serves as a cup receiving area 148. The outside dimensions of the cup receiving area is thus defined by the encircling belt 146. In a first position, outside circumference of the cup-receiving area 148 is greater than the outside circumference of a cup to be dispensed.

The belt is coupled to a mechanism for tightening the same around the outside of a cup. In an embodiment, one end of the belt 146 is attached to a wheel 150 that is coupled to a bi-directional motor. When the wheel 150 is rotated such that the belt 146 begins to wind around the circumference of the wheel, the belt tightens around a cup that is located in the cup-receiving area 148. The motor is reversed to loosen the belt 146 to release a cup.

As shown if FIG. 18, in a preferred embodiment the bottom of the belt mechanism is provided with a floor 152 made of plastic, thermoplastic or any such similar material The opening of belt mechanism optionally comprises a plastic material having a cut-out 154 roughly shaped and sized to accommodate a cup.

In use, the belt mechanism 144 is positioned below a pull-type cup dispenser with its cup area open and ready to receive a cup within its confines. To dispense a cup, the belt mechanism 144 is mechanically raised, for example, by way of a linear track, until the bottom cup extending from a cup dispenser is within the cup receiving area 148. A belt tightening mechanism is then activated to tighten the belt 146 around the outside walls of a cup. With belt 146 tightened around a cup, the belt mechanism 144 is then mechanically lowered. A cup that is gripped by belt is thusly removed from a stack The belt 146 is loosened to release a cup.

The belt mechanism could be adapted to dispense wide range of cup sizes. For example, in one embodiment, a belt is configured to define a cup-receiving area 148 that may receive a 64 oz. Vending cup. In order to grip a 64 oz cup a certain number of rotations (or partial rotations) of wheel 150 would be necessary to sufficiently tighten the belt 146 around the outside of the cup The belt mechanism could be programmed for wheel 150 could make extra rotations (or partial rotations) such that the belt tightens enough to grip a smaller, 32 oz. Vending cup. Importantly, the current embodiment is able to dispense Styrofoam cups.

It will be understood by those of ordinary skill in the art, that the dispenser described herein can dispense cups or packages that are not necessarily nested in a stack. For example, single serving soups or cereals are commonly sold in containers that are sealed on top. These containers may be stacked, upright or otherwise, inside a vending machine and by suctionally adhering their tops or bottoms, the cup dispenser disclosed herein can dispense these containers.

Having described the invention with respect to specific embodiments and the exemplary attached drawings, it should be understood that the foregoing description is not intended to limit the scope of the present invention but merely serves as examples as how one of ordinary skill in the art can make or use the invention.

What is claimed is:

1. An apparatus for dispensing cups, comprising:
a suctioning device attached to a z movement device, said suctioning device comprising a downward pointing suction tip;
a stack of cups positioned below said suctioning device;
a cup rotating mechanism for receiving a cup in an upside down orientation and rotating said cup by 180°; and
software configured to control said z movement device.

2. The apparatus of claim 1, wherein said suctioning device comprises one of a peristaltic pump or an inflator/deflator pump.

3. The apparatus of claim 1, wherein said z motion mechanism comprises a pulley wheel and a cord having a first end tethered to said pulley wheel and a second end attached to a suctioning device.

4. The apparatus of claim 1, wherein said z movement mechanism comprises a linear track.

5. The apparatus of claim 1, wherein said cup rotating mechanism comprises a rotatable wall, said rotatable wall having support members protruding therefrom.

6. The apparatus of claim 1, wherein said suctioning device is enclosed within an elevator, said elevator comprising side walls, a top wall, a bottom wall and angled junctions.

7. The apparatus of claim 1, further comprising an elevator guide and a cup storage compartment, said elevator guide being movable to align with said cup storage compartment

8. The apparatus of claim 1, further comprising an infrared detector positioned on said z movement mechanism.

9. The apparatus of claim 8, wherein said infrared detector detects the presence of a cup.

10. The apparatus of claim 9, wherein said infrared detector is configured to travel a measured distance after detecting said cup to reach said cup.

11. The apparatus of claim 1, wherein said software is configured to store a count of cups in memory.

12. An apparatus for dispensing cups comprising:
a pair of biasing pins, said pins pivotably connected to a pivoting member, said pivoting member being rotatable in a first direction to extend said pins, said pivoting member being rotatable in a second direction to retract said pins.

13. The apparatus of claim 9, wherein said apparatus is attached to a z movement device.

14. An apparatus for dispensing a bottom cup comprising:
a pull-type cup dispenser;
a mechanism comprising a belt said belt configured to define a cup-receiving area;
a belt-tightening mechanism for tightening said belt around a cup.

15. The apparatus of claim 14, wherein said belt-tightening mechanism is adjustable to tighten around various sizes of cups.
